(19) United States
(12) Patent Application Publication
(10) Pub. No.: US 2010/0211221 A1
(43) Pub. Date: Aug. 19, 2010

(54) Method For Controlling A Cryogenic Distillation Unit

(75) Inventors: Jean-Francois Rauch, Joinville-Le-Pont (FR); Athanasios J. Kontopoulos, Lesigny (FR); Jean-Marc Peyron, Creteil (FR); Thierry Roba, Boneffe (BE)

Correspondence Address: AIR LIQUIDE USA LLC;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude, Paris (FR)

(21) Appl. No.: 12/598,852

(22) PCT Filed: Apr. 25, 2008
(86) PCT No.: PCT/FR08/50759

§ 371 Date: Mar. 23, 2010

(30) Foreign Application Priority Data
May 11, 2007 (FR) 0755020

(51) Int. Cl. G05B 15/00; F25J 3/00

(52) U.S. Cl. 700/275; 62/656

(57) ABSTRACT

A method for controlling a cryogenic distillation unit, for example an air separation unit or a unit for separating a mixture having hydrogen and carbon monoxide as its main components is presented.

The present invention relates to method for controlling a cryogenic distillation unit, for example an air separation unit or a unit for separating a mixture having hydrogen and carbon monoxide as its main components.

The control process according to the invention uses the multivariable predictive control method and optionally the non-predictive control method such as the Advanced Feed Forward (AFF) strategy.

The approach is illustrated through examples, in particular the rapid rate change and the optimization of the argon extraction yield.

The air distillation process is not discussed in detail here, being sufficiently explained in the literature, for example in “Oxygen Enhanced Combustion” Editions CRC, 1998, “Tieftemperaturtechnik” by Hausen and Linde, etc.

In short, this method is used to produce oxygen, nitrogen and argon (more rarely krypton and xenon) by compressing and then cooling (liquefying) and distilling ambient air.

In a conventional system, the air is compressed and then separated using low and medium pressure columns (which are more and more frequently superimposed and which communicate thermally via an oxygen/nitrogen heat exchanger called vaporizer-condenser). In the medium pressure column, the nitrogen is separated from the air by creating an oxygen-rich liquid at the bottom of the column and nitrogen-rich liquid and vapor at the top of the column. These products are extracted and at least some of them are fed separately to the low pressure column. Due to the differences in relative volatility between argon, nitrogen and oxygen, practically pure nitrogen is formed at the top of the column, practically pure oxygen is formed at the bottom of the column, and argon-rich gas at the middle of the column. The central, argon-rich fraction, often called crude argon, can be withdrawn from the low pressure column to feed an auxiliary column (argon) in order to produce argon. The crude argon is rectified to an oxygen-rich reflux (which is then sent to the low pressure column to be condensed therein) and a highly argon-rich stream (often called mixture argon) which can be used as a product as such or subsequently purified.

In a modern unit, it is rare for the set point values of the flow rates of incoming air, nitrogen, oxygen and argon produced, and those of the intermediate streams (for example, flow rates of liquid rises from the high pressure column to the low pressure column) to be fixed. Control systems are used simultaneously to meet the product quality specifications (contents) while producing the requisite quantities and, increasingly, to meet the requirements associated with Safety and the Environment.

These control systems are often of the Advanced Feed Forward (AFF) type and, more recently, of the Multivariable Predictive Control (MVPC) type.

Both systems have advantages and drawbacks. The present invention proposes a combined system which optimizes the use of both of them.

The present invention relates to a method for controlling a cryogenic distillation separation apparatus in which at least one manipulated variable is modified, the manipulated variable or each of the manipulated variables being modified using at least one controlled variable, each controlled variable being adjustable using a control method characterized in that a predictive control method is used to control at least one set point of a first controlled variable.

According to other aspects:
at least one set point of a first controlled variable controlled by the predictive method is used to calculate, by a non-predictive method, optionally of the Advanced Feed Forward type, at least one set point of at least one second controlled variable,
at least one set point, derived from a set point of one of the controlled variables controlled by the predictive method, is used to calculate, by a non-predictive method, optionally of the Advanced Feed Forward type, at least one set point of at least one second controlled variable,
the set point is derived from a set point of one of the controlled variables controlled by the predictive method by filtering, optionally by ramp filtering,
the first controlled variable is a feed air flow rate for a cryogenic distillation air separation apparatus in a double column comprising a medium pressure column and a low pressure column and the second controlled variable is a flow rate of reflux liquid from the medium pressure column and/or sent to the low pressure column or a level of a vessel of reflux liquid (Capa) from the medium pressure column and sent to the low pressure column,
the calculated value of the set point of reflux liquid going from the medium pressure column to the vessel is processed by lead-lag filtering, preferably the inverse response alternative,
the calculated value of the set point of reflux liquid going from the vessel to the low pressure column is processed by lead-lag filtering, preferably the overshoot alternative,
the reflux liquid is enriched with nitrogen,
the method is a method for controlling an air separation apparatus comprising a medium pressure column, a low pressure column and an argon separation column and the first controlled variable is the oxygen content at a predefined height of the low pressure column, where the argon content is preferably a maximum in which

i) the nitrogen content at the top of the argon separation column is measured and if the nitrogen content exceeds a first threshold, at least one upper or lower limit is increased for the first controlled variable and/or

ii) the oxygen content of an oxygen rich stream withdrawn from the low pressure column is measured and if the oxygen content falls below a second threshold, at least one upper or lower limit is increased for the first controlled variable,
at least one upper or lower limit is increased by at least 0.1%, preferably by at least 0.5%,
at least one upper or lower limit is increased instantaneously,
either

i) once the nitrogen content has exceeded the first threshold, if the nitrogen content then falls below a third lower threshold, equal to or higher than the first threshold, at least one upper or lower limit is reduced for the first controlled variable and/or

ii) once the oxygen content has fallen below a second threshold, if the oxygen content then exceeds a fourth lower threshold, equal to or higher than the second threshold, at least one upper or lower limit is reduced for the first controlled variable,
at least one upper or lower limit is reduced by at least 0.1%, preferably by at least 0.2%,
at least one upper or lower limit is reduced for a period of at least 10 minutes,
the first threshold is at least 0.2% nitrogen, preferably at least 0.3% and optionally the third threshold is equal to the first threshold.

The invention will be described in greater detail with reference to the Figures.

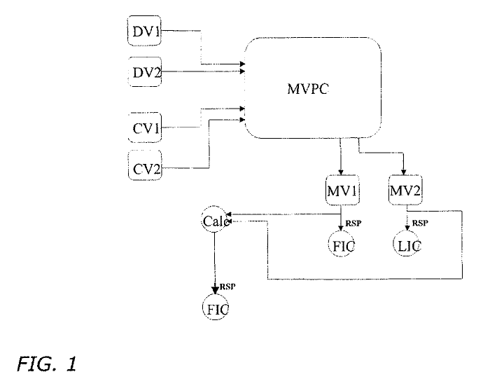

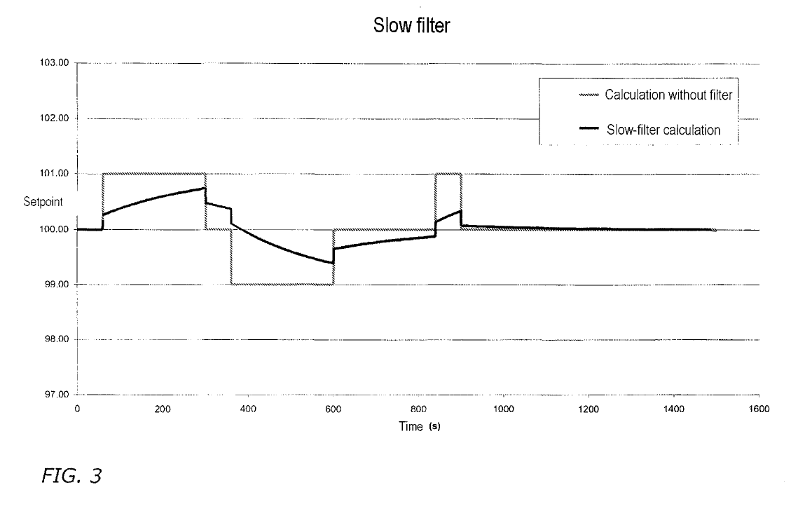

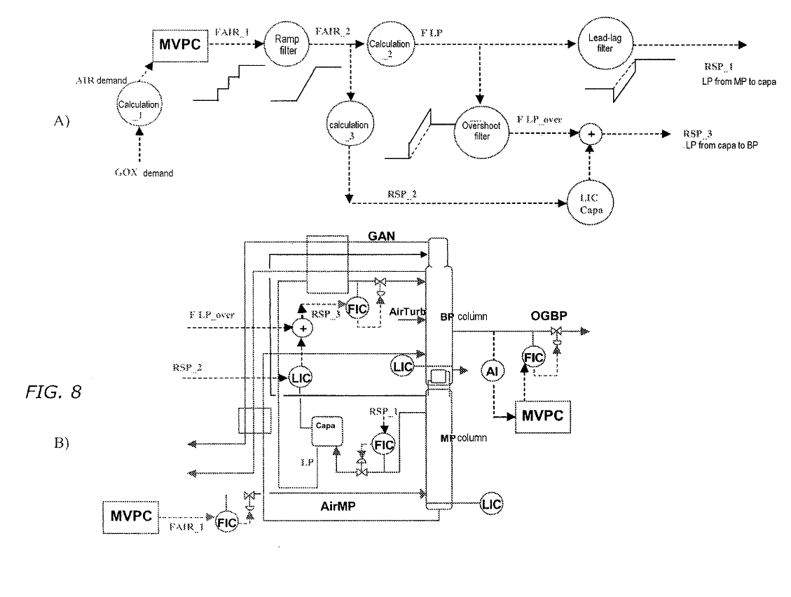

FIGS. 1, 2 and 7 schematically show control methods according to the invention, FIGS. 3 to 6 show the effect of the filtering systems, which can be used in the context of the invention, FIG. 8A shows a control method according to the invention in the context of the air separation apparatus of FIG. 8B and FIGS. 9 and 10 are graphs showing the variables controlled according to the inventive method.

The invention consists of a combined process control system which serves to benefit from the advantages of both of the two AFF and MVPC systems.

The first step consists in defining the control matrix, that is the MV (Manipulated Variables), the CV (Controlled Variables) and the DV (Disturbances and/or observable Deviations).

By using the knowledge of the process: the static behavior of the unit (thermodynamic equilibrium, etc.) as well as the dynamic behavior (hydraulic flow and dynamic retention), the equations between certain variables controlled by the SNCC (Numerical Monitoring-Control System) are defined, as well as other variables of the control matrix (DV and MV). Subsequent calculations can optionally be performed from the values of MV and the results of these calculations are new set points, as shown in FIG. 1. The MVPC controller receives the values DV1, DV2 of disturbances and the values CV1, CV2 of controlled variables. Based on these values, the MVPC controller calculates (using dynamic correlations as explained below as well as various ad hoc parameters) new set points (RSP), for the manipulated variables, MV1, MV2 and these new set points are sent to controllers of various types (for example, to a Flow Indicator and Control (FIC) or a Level Indicator and Control (LIC)). In the present case, this example concerns a flow controller. In general, these equations use one or more Manipulated Variables.

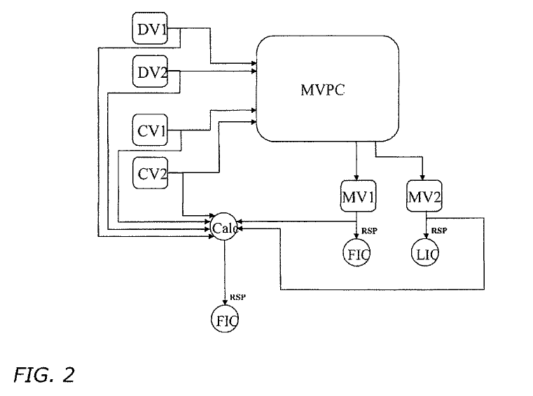

But in certain cases, it is also possible to use one or more Disturbances (DV1, DV2) and one or more Controlled Variables (CV1, CV2) to generate new set points (RSP or Remote Set Point) for a flow controller (FIC) and a level controller (LIC), by combining with the values of certain manipulated variables (MV1, MV2), as shown in FIG. 2. The difference between FIG. 1 and FIG. 2 is that in the case of FIG. 2, certain CV and DV participate in the calculation of the value of certain calculated set points (RSP) which are transmitted to FIC, LIC type controllers, etc., without passing through the MVPC.

In certain cases, the values of the Manipulated Variables are used directly. Since these are recalculated at each calculation cycle of the predictive multi-variable controller, the set point calculation yields increments.

As a rule, the value from the controller passes through a filter to pass from the discrete domain to the continuous domain.

This serves to use slow filters (first order for example) to have set points which vary slowly (for systems with high inertia) as shown in FIG. 3.

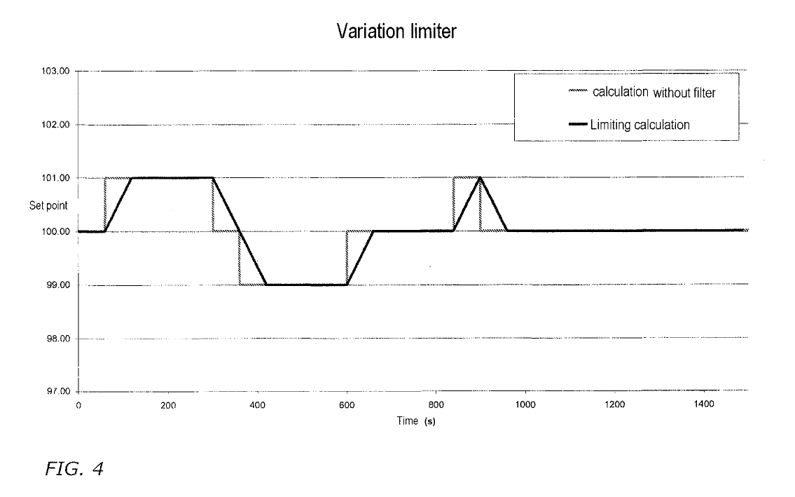

On other occasions, we use filters which limit the variations like the one in FIG. 4.

Another type of filtering is the lead-lag (or advance/delay) type, to provide a dynamic to the change in set point.

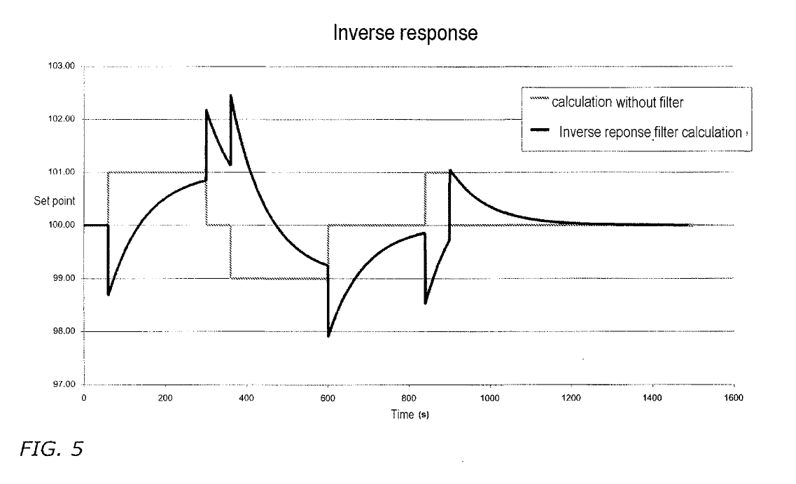

We have lead-lags of the “inverse response” type (FIG. 5): when the set point given by the controller increases, the signal first starts to be reduced, and then increases to the desired value.

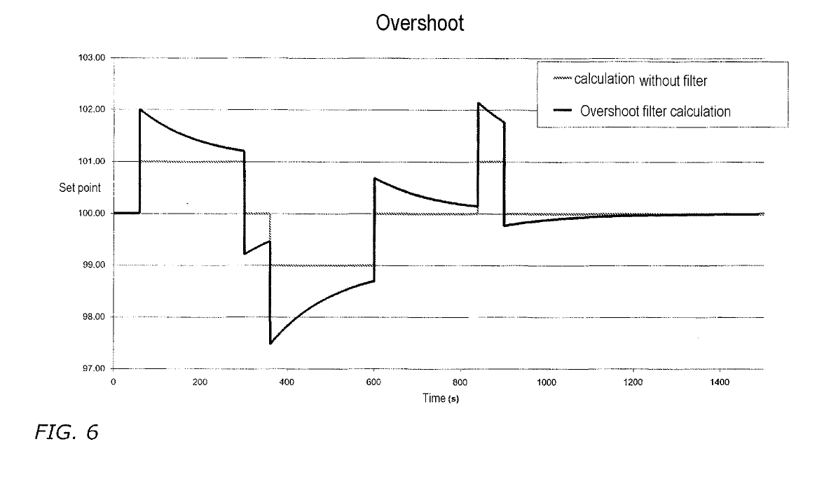

Another type is that of the “overshoot” type: the filter temporarily amplifies the changes in set point (FIG. 6).

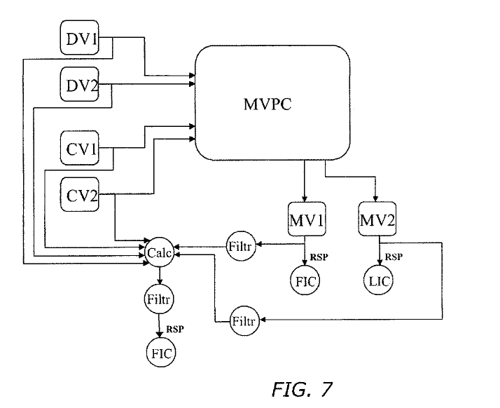

It is unnecessary to employ only one filter, and we can use a combination of several filters. As shown in FIG. 7, a first filter is used to modify the value of MV1, a second filter is used to modify the value of MV2, and a third filter is used to modify the value of the set point produced by calculation.

Many advantages are obtained:
First, the size of the matrix of the multivariable controller is reduced (above all, fewer Manipulated Variables). The system is therefore easier to use.
Less time spent to identify the models (correlations expressing dynamic links between the CV and the DV and MV) of the system (this time is directly proportional to the number of Manipulated Variables).
Less communication between the SNCC and the PC which contains and runs the MVPC software (the most frequent case).
Less setup (programming) in the SNCC.
Fewer adjustment parameters in the MVPC controller (faster startup).
More robust controller.

The system according to the invention serves to optimize the production unit. The optimization variables are included in the matrix. The linear or rms optimization program is used to find the optimum of the operating point of the unit by pushing the control variables against their limits.

However, the inventive system also serves to make very rapid rate changes. In fact, since part of the control loop is predefined, this serves to anticipate the load changes of the unit.

This system therefore serves both to optimize and to make load variations between 0.1%/min (pseudo-static rate change) and more than 7%/min (very rapid rate change).

The effectiveness of the inventive method in the context of a rapid rate change (up to 7% of the product flow rate/minute) will be demonstrated by using FIGS. 8A and 8B.

In FIG. 8B, a double column comprises a medium pressure column MP and a low pressure column BP thermally connected together by a vaporizer-condenser. The apparatus produces low pressure oxygen in gaseous form OGBP at the bottom of the BP column.

Medium pressure air AirMP is sent to the medium pressure column MP and expanded air AirTurb is sent to the BP column.

Rich liquid is sent from the bottom of the MP column to the BP column.

Nitrogen-rich liquid LP called low poor liquid is sent to a vessel C and liquid from the vessel is sent to the BP column.

High poor liquid is sent from the MP column to the BP column.

The aim is to very rapidly increase and/or decrease air feed of an air separation unit in order to adapt it faster to consumption demand. It is understood that these load changes must satisfy the safety requirements and the quality specifications of the delivered product.

To maintain the purities within the specifications of an air separation unit equipped with a system according to the invention, we must maintain the refluxes as constant as possible in:
the Low Pressure Column (BP)
the Medium Pressure Column (MP)

In the case of very rapid rate changes, the solution to this problem cannot be found exclusively in the control system. This is because during a rapid rate change, the gas flow rates in the column (MP as well as BP) are modified faster than the liquid flow rates (which are modified much slower, because of liquid holdup, whether concerned with trays or packings in the columns). This creates a drastic change in the reflux values in the column with, as an immediate consequence, a loss of contents and a suspension of production.

The solution according to the invention is to exploit all the liquid vessels of the column, or even to install an additional one, which, managed by an effective control system, guarantees sufficient reflux so that the purities are also maintained during rate changes.

A brief glance of the installation is provided in FIG. 8.

An additional vessel is installed in order to benefit from a volume of liquid required during a rapid rate change. The useful volume of this vessel may be based on detailed calculations (dynamic modeling). The vessel C is filled with oxygen-Poor Liquid (LP) from the MP column and the departing liquid is sent to the BP column at an ad hoc location.

The filling/drainage principle of vessel C is as follows: when the air flow rate (feed to the unit) is at its highest value, the level of the vessel is at its lowest (for example 20%) and when the air flow rate is at the lowest possible value, the set point of the new liquid in the vessel is the highest possible (for example 40%, 50% or 80%).

This relatively simple principle must nevertheless be managed by an effective control system because the vessel filling or drainage flow rates must not be modified purely in proportion to the air flow rate. This is due to the fact that the dynamic impact of the change in air flow rate and that of the LP on the reflux are not the same. These differences must therefore be managed by an appropriate control system in order to keep the reflux as stable as possible. At the same time, they must maintain the level of the vessel at the right value. This therefore brings us to three set points (Remote Set Point) to be calculated at all times (see FIG. 8):
RSP_1: the flow rate set point of poor liquid (LP) from MP and toward the vessel C
RSP_2: the set point of the LIC of the vessel C
RSP_3: the flow rate set point of LP from the vessel to the BP column.

Furthermore, to carry out the rate change, we must guarantee a suitable change in the air flow rate and also in the OGBP (Low Pressure Oxygen Gas) flow rate in order to:
satisfy demand for OGBP production as rapidly as possible
keep the OGBP content to within the imposed limits.

We accordingly make use of a combination of various types of filters in combination with the AFF method and the MVPC (to exploit the possibilities of multivariable and predictive management of the variables).

To summarize, in the present case:
the BP flow rates to and from the additional vessel managed by an AFF method with appropriate use of various filters (see FIG. 8). This helps to keep the reflux at the right value in the column,
the air and OGBP flow rates are managed by the MVPC. This guarantees the production of OGBP at the desired value and the maintenance of the OGBP content.

In fact, if we observe FIG. 8A:
oxygen demand (GOX demand) is reflected by a suitable calculation (calcul_{—}1) as an Air flow rate demand (this is also justified by the fact that the unit can share a feed air network—and an oxygen-production network—with other units),
the MVPC, by taking account of this OGBP demand, the possibilities of the air compressor at this time, of the OGBP content, the value of the disturbance variables, etc. will propose new set points for Air (FAIR_{—}1) and OGBP.
the new set point for air, FAIR_{—}1, has a “stairway” shape because the MVPC needs time for its calculations, it therefore sends a set point (RSP) to the PID every minute, or every 30 seconds, etc. It will be unacceptable to the “AFF/vessel RSP management” system to have such a “fractionated” input. Use is therefore made of a “ramp” filter to “smooth” this set point before transmitting it to the flow rate management of the additional vessel. This gives us a new set point (FAIR_{—}2),
this new set point, through a calculation (calcul_{—}2, for example of the ax+b type) is translated into a flow rate of Poor Liquid (F LP) which represents the poor liquid flow rate in steady state conditions.

The dynamic requires us to use this flow rate to:
calculate a set point (remote set point) of LP from MP to the vessel (RSP_{—}1). This calculation requires passage via a lead-lag (inverse response) filter,
calculate a set point (remote set point) (RSP_{—}3) for the LP from the vessel to the BP column having passed through:
   an “overshoot” filter
   a calculation (of the −ax+b type, calcul_{—}3) to which a correction of the LIC of the vessel is added.

In this way, we obtain the dynamic management of this event (rapid rate change) by having usefully combined an AFF type management with the MVPC. This is the principle of the present invention. In fact, the intrinsic predictive and multivariable capacities of the MVPC help to speed up the operation while complying with the limits of the OGBP content.

At a facility which has to respond very rapidly to the rate changes of an oxygen consumer, we installed a MACCS system based on the principles described above.

The purity of the oxygen gas produced must generally be maintained close to 95% and in any case between 94% at the lowest (contractual content) and 96.5% at the highest (for safety reasons).

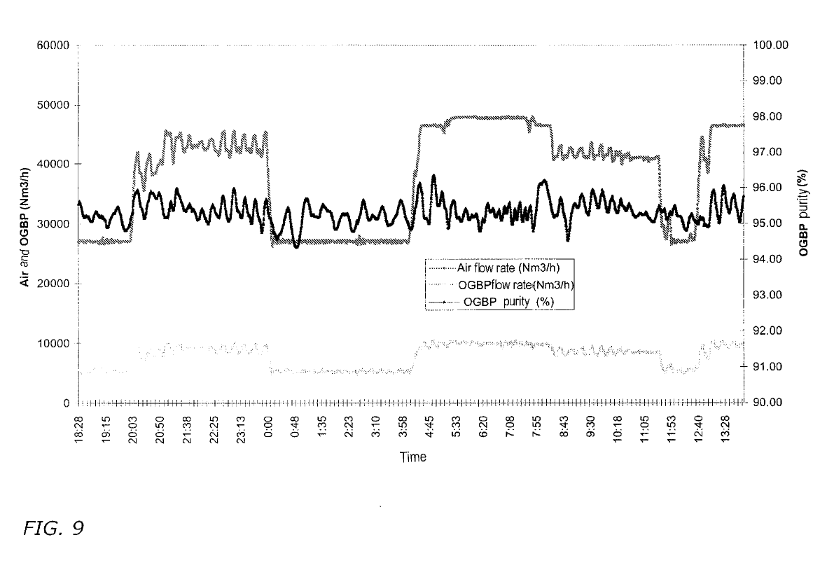

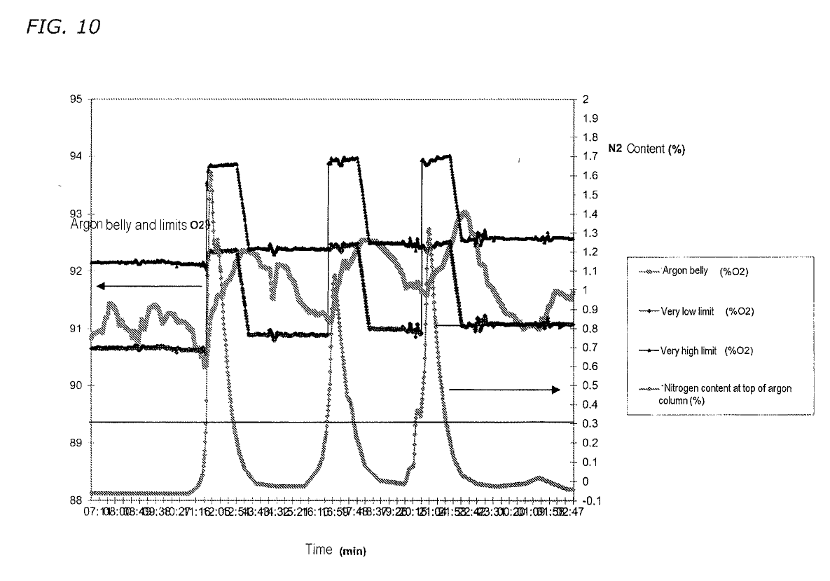

The variation in various parameters is shown in FIGS. 9 and 10. The rate changes take place rapidly but while keeping the OGBP content within the desired limits.

The AFF portion (with filters) controls the entire part concerning the flow rates of the additional vessel and the MVPC, the air flow rate and the OGBP flow rate.

Another use of the system according to the invention is the optimization of the argon extracted from an air separation unit (ASU).

Reference can be made to the brief description of an air separation unit provided above.

The crude argon stream (from the low pressure column to the argon column) contains a percentage of nitrogen. The presence of nitrogen raises many operational concerns when argon is being distilled.

This is because, to extract the maximum of argon, the argon “belly” (oxygen content at the location of the low pressure column where the argon stream is to be withdrawn) must be kept as low as possible. This stems from the basic principles of distillation, and is a well known rule in operations. On the contrary, an excessively low value of the argon belly has the consequence of an excessively high presence of nitrogen at the top of the argon distillation column, which prevents this column from operating properly. These mechanisms are imminently nonlinear. The result is a loss of content of the pure products and an involuntary tripping of the operating unit.

The MVPC systems installed on air distillation columns encounter serious problems in taking account of this occurrence, because the models that would reproduce the presence of nitrogen at the top of the argon column as a function of various parameters, are highly nonlinear and are difficult to manage by a “purely” MVPC approach.

In the case of an MVPC approach on a basic system (by way of example) to control the argon belly of a column, we can construct the following system:

Manipulated variables, MV (of which the set point is proposed by the MVPC system)

MV1: Air flow rate

MV2: Low pressure oxygen gas (OGBP) flow rate

Controlled variables, CV (of which the value must be maintained between two limits—high and low—whenever possible by the MVPC, by manipulating the MV variables).

CV1: The value of the argon belly—oxygen content at a predefined height of the low pressure column (in %)

CV2: The “objective” value of the air flow rate (target air) which must be satisfied for production reasons.

Disturbance Variables, DV (which the MVPC does not manipulate but whose influence on the CV variables is determined by models):

DV1, DV2 . . . : Measurement-set point deviation for Air, OGBP flow rates, etc. (the flow rates being incorporated in the MV variables).

DVx, DVx+1: Optionally, impact of the pressurization of the top stripping cylinders, Medium or High Pressure OG Flow Rate, Medium or High Pressure Nitrogen Gas Flow Rate, etc.

Obviously, this configuration is an example, and various configurations between the MV, CV and DV can be considered to solve the same problem.

In the case of our Combined approach, we pursue the following strategy:

1. Set a threshold for the presence of nitrogen at the top of the argon column. This may typically be about 0.2% to 1% but it may be higher or lower, depending on the particular characteristics of each column. Let us call this threshold (A).

2. When threshold (A) is exceeded, the values of the very low limits, low limit, high limit and very high limit, which are transmitted to the MVPC as limits in which the variable CV1 (argon belly) must be maintained, are all instantaneously increased by a predefined value (let us call this: V1) which depends on the process and which may typically be about 0.2% to 3% and more typically between 0.5% and 1.5%. This value (V1), which shifts all the limits upward, is called “Automatic Bias”.

3. When the value of the nitrogen analysis at the top of the column then falls below a threshold (B) which may either be equal to the threshold (A) or (B)=(A)+/−(C), where (C) is a value ensuring a hysteresis (typically about 0.1% to 0.5% in the case examined), the V1 is then removed from the limit values of the belly, preferably not instantaneously but rather with a ramp (−V1/min) to prevent a sudden return to the initial value of the set point of the argon belly.

This technique serves to avoid inadvertent trippings of the unit which generate losses in production, energy losses, as well as potential dangers of accidental tripping of the production unit and, at the same time, to preserve an optimal (very low) argon belly set point, which serves to optimize the extraction of argon.

The principles set forth above are demonstrated and proved by the example shown in FIG. 10.

To help clarify the summary, only the values of the very low limit and the very high limit are presented, but the low limit and the high limit are also increased by the same value (V1).

In the case presented:

Bias activation threshold (A)=0.3% nitrogen at top of argon column

Bias deactivation threshold (B)=(A)=0.3%

Value (V1) of automatic bias: 1.5% which is automatically added to the limits of the argon belly transmitted to the MVPC.

Ramp time to return to the initial value of the belly set point: 30 minutes.

Furthermore, in the case presented, all the limits of CV1 (argon belly) are calculated from a set of parameters such as the load of the unit, the flow rate of impure oxygen produced, etc.

It may be observed that the presence of nitrogen is highly nonlinear, hence the need to consider this occurrence by this technique outside the MVPC.

It should also be observed that the activation of this automatic bias is not necessarily exclusively associated with the presence of nitrogen at the top of the argon column, but may be connected to the presence of other mechanisms, such as the overshoot of a low threshold of an oxygen content (e.g. the low pressure oxygen content produced by the low pressure column, etc.).

For certain controlled variables, of which the dead time is longer than 15 minutes, a predictive control method is used. For example, a change in product flow rate from the impure argon column supplied from the low pressure column has an impact on the oxygen content measured in the column, of which the dead time exceeds 15 minutes. The oxygen content of the impure argon column will therefore be controlled by a predictive method.

1-15. (canceled)

16. A method for controlling a cryogenic distillation separation apparatus comprising:
a) modifying at least one manipulated variable, the at least one manipulated variable being modified using at least one controlled variable,
b) adjusting the at least one controlled variable using a control method wherein a predictive control method is used to control at least one set point of a first controlled variable.

17. The method of claim 16, in which at least one set point of the first controlled variable controlled by the predictive method is used to calculate, by a non-predictive method, at least one set point of at least one second controlled variable.

18. The method of claim 17, wherein the predictive method uses an advanced feed forward type of non-predictive method to calculate the at least one set point of the at least one second controlled variable.

19. The method of claim 16, in which at least one set point, derived from a set point of one of the controlled variables controlled by the predictive method, is used to calculate, by a non-predictive method, at least one set point of at least one second controlled variable.

20. The method of claim 19, wherein the predictive method uses an advanced feed forward type of non-predictive method to calculate the at least one set point of the at least one second controlled variable.

21. The method of claim 19, in which the set point is derived from a set point of one of the controlled variables controlled by the predictive method by filtering.

22. The method of claim 21, wherein the predictive method of filter is ramp filtering.

23. The method of claim 17, in which the first controlled variable is a feed air flow rate for a cryogenic distillation air separation apparatus in a double column comprising a medium pressure column and a low pressure column and the second controlled variable is a flow rate of reflux liquid from the medium pressure column and/or sent to the low pressure column or a level of a vessel of reflux liquid (Capa) from the medium pressure column and sent to the low pressure column.

24. The method of claim 23, in which the calculated value of the set point of reflux liquid going from the medium pressure column to the vessel is processed by lead-lag filtering.

25. The method of claim 24, wherein the lead-lag filtering is the inverse response alternative.

26. The method of claim 23, in which the calculated value of the set point of reflux liquid going from the vessel to the low pressure column is processed by lead-lag filtering.

27. The method of claim 26, wherein the lead-lag filtering is the overshoot alternative.

28. The method of claim 23, in which the reflux liquid is enriched with nitrogen.

29. The method of claim 16, for controlling an air separation apparatus comprising a medium pressure column, a low pressure column and an argon separation column and the first controlled variable is the oxygen content at a predefined height of the low pressure column, where the argon content is a maximum in which
i) the nitrogen content at the top of the argon separation column is measured and if the nitrogen content exceeds a first threshold, at least one upper or lower limit is increased for the first controlled variable and/or
ii) the oxygen content of an oxygen rich stream withdrawn from the low pressure column is measured and if the oxygen content falls below a second threshold, at least one upper or lower limit is increased for the first controlled variable.

30. The method of claim 29, in which at least one upper or lower limit is increased by at least 0.1%.

31. The method of claim 30, wherein at least one upper or lower limit is increased by at least 0.5%.

32. The method of claim 29, in which at least one upper or lower limit is increased instantaneously.

33. The method of claim 29, in which either
once the nitrogen content has exceeded the first threshold, if the nitrogen content then falls below a third lower threshold, equal to or higher than the first threshold, at least one upper or lower limit is reduced for the first controlled variable and/or
once the oxygen content has fallen below a second threshold, if the oxygen content then exceeds a fourth lower threshold, equal to or higher than the second threshold, at least one upper or lower limit is reduced for the first controlled variable.

34. The method of claim 33, in which at least one upper or lower limit is reduced by at least 0.1.

35. The method of claim 34, in which at least one upper or lower limit is reduced by at least 0.2%.

36. The method of claim 33, in which at least one upper or lower limit is reduced for a period of at least 10 minutes.

37. The method of claim 29, in which the first threshold is at least 0.2% nitrogen.

38. The method of claim 29, in which the first threshold is at least 0.3%.

39. The method of claim 29, in which the third threshold is equal to the first threshold.
